(19) United States
(12) Patent Application Publication
(10) Pub. No.: US 2021/0073892 A1
(43) Pub. Date: Mar. 11, 2021

(54) PRODUCT ORDERING METHOD

(71) Applicant: Beijing Sankuai Online Technology Co., Ltd, Beijing (CN)

(72) Inventor: Xiaowei SHI, Beijing (CN)

(21) Appl. No.: 17/098,417

(22) Filed: Nov. 15, 2020

Related U.S. Application Data
(63) Continuation of application No. PCT/CN2018/120566, filed on Dec. 12, 2018.

(30) Foreign Application Priority Data
May 15, 2018 (CN) 201810463910.1

(51) Int. Cl. G06Q 30/06; G06Q 10/08; G06Q 30/02; G06N 20/00

(52) U.S. Cl. CPC G06Q 30/0631; G06Q 10/087; G06N 20/00; G06Q 30/0201; G06Q 30/0635

(57) ABSTRACT

A product ordering method, including: determining, according to real-time data of secondary products hung under primary products, merchantable secondary products hung under the primary products and secondary product types of the merchantable secondary products (110); determining primary product features of the primary products and user preference features of a target user based on the merchantable secondary products and the secondary product types (120); and ordering the primary products according to the primary product features and the user preference features (130).

### CROSS-REFERENCE TO RELATED APPLICATION

This disclosure is a Continuation Application of International Application No. PCT/CN2018/120566, which claims priority to Chinese Patent No. 201810463910.1 entitled “PRODUCT ORDERING METHOD AND APPARATUS, ELECTRONIC DEVICE, AND STORAGE MEDIUM” filed on May 15, 2018, which is incorporated herein by reference in its entirety.

### TECHNICAL FIELD

This disclosure relates to the field of computer technologies, and in particular, to a product ordering method and apparatus, an electronic device, and a storage medium.

### BACKGROUND

Current online travel agency (OTA) websites provide search, filter, and recommendation functions. The OTA websites with the functions can retrieve a set of eligible primary products such as hotels according to query terms or filter conditions or user preferences of a user, and order the hotels and then present the hotels to the user, thereby helping the user quickly find suitable hotels. For example, the hotels are ordered according to the priorities of distances, high prices, low prices, scores, sales, and the like, to provide a set of hotels that meet the needs of the user. However, in actual application, a user has very complex requirements, for example, one or more sub-products hung under the hotels need to be quickly and accurately retrieved. Other application fields, such as beauty and eat-in catering, also involve ordering of primary products based on only attributes of the primary products.

It may be learned that ordering based on only the attributes of the primary products cannot effectively meet more complex requirements of users in practice.

### SUMMARY

In order to resolve the above problem, in a first aspect, an embodiment of this disclosure provides a method being implemented by a computing system for providing a recommendation to a terminal device associated with a user. The method includes: obtaining information from a storage device real-time data of secondary products under primary products; determining, according to real-time data of secondary products hung under primary products, merchantable secondary products hung under the primary products and secondary product types of the merchantable secondary products; determining primary product features of the primary products and user preference features of a target user based on the merchantable secondary products and the secondary product types; ordering the primary products according to the primary product features and the user preference features, and sending information regarding the ordered the primary products to the terminal device for display to the user.

According to a second aspect, an embodiment of this disclosure provides an apparatus comprising a processor configured to execute program components to cause the apparatus to perform various operations, wherein program components include: a merchantable secondary product and secondary product type determining module configured to determine, according to real-time data of secondary products hung under primary products, merchantable secondary products hung under the primary products and secondary product types of the merchantable secondary products; a primary product feature and user preference feature determining module configured to determine primary product features of the primary products and user preference features of a target user based on the merchantable secondary products and the secondary product types determined by the merchantable secondary product and secondary product type determining module; and an ordering module configured to order the primary products according to the primary product features and the user preference features determined by the primary product feature and user preference feature determining module. The apparatus is caused by the processor to perform: sending information regarding the ordered the primary products to the terminal device for display to the user

According to a third aspect, an embodiment of this disclosure further discloses an electronic device. The electronic device includes a memory and a processor. The memory stores a computer program executable on the processor. When the processor executes the computer program, the product ordering method according to the embodiment of this disclosure is implemented.

According to a fourth aspect, an embodiment of this disclosure provides a non-transitory computer-readable storage medium storing a computer program. When the computer program is executed by a processor, the product ordering method according to the embodiment of this disclosure is implemented.

According to the product ordering method disclosed in the embodiment of this disclosure, the merchantable secondary products hung under the primary products and the secondary product types of the merchantable secondary products are determined according to the real-time data of the secondary products hung under primary products, and then the primary product features of the primary products and the user preference features of the target user are determined based on the merchantable secondary products and the secondary product types, and the primary products are ordered according to the primary product features and the user preference features. Since the products are ordered based on the real-time data of the secondary products hung under the primary products and the primary product features and the user preference features determined based on the secondary products from a perspective of product information and user preferences, users can quickly find appropriate secondary products hung under the primary products, effectively improving accuracy of product ordering.

### BRIEF DESCRIPTION OF THE DRAWINGS

To describe the technical solutions of the embodiments of this disclosure more clearly, the following briefly describes the accompanying drawings required for describing the embodiments or the prior art. Apparently, the accompanying drawings in the following description show some embodiments of this disclosure, and a person of ordinary skill in the art may still derive other drawings from these accompanying drawings without creative efforts.

FIG. 1 is a flowchart of a product ordering method according to Embodiment 1 of this disclosure.

FIG. 2 is a flowchart of a product ordering method according to Embodiment 2 of this disclosure.

FIG. 3 is a schematic diagram of application of a product ordering method in a specific application scenario according to an embodiment of this disclosure.

FIG. 4 is a schematic structural diagram of a product ordering apparatus according to Embodiment 3 of this disclosure.

FIG. 5 is another schematic structural diagram of a product ordering apparatus according to Embodiment 3 of this disclosure.

FIG. 6 is a schematic structural diagram of an electronic device according to an embodiment of this disclosure.

FIG. 7 is a schematic structural diagram of an example environment according to an embodiment of this disclosure.

### DETAILED DESCRIPTION OF THE EMBODIMENTS

The following clearly and completely describes the technical solutions in the embodiments of this disclosure with reference to the accompanying drawings in the embodiments of this disclosure. Apparently, the described embodiments are some embodiments of this disclosure rather than all of the embodiments. All other embodiments obtained by a person of ordinary skill in the art based on the embodiments of this disclosure without creative efforts shall fall within the protection scope of this disclosure.

### Embodiment 1

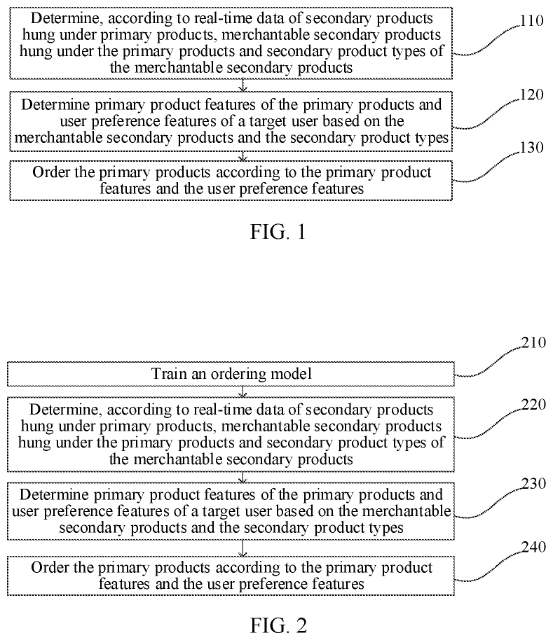

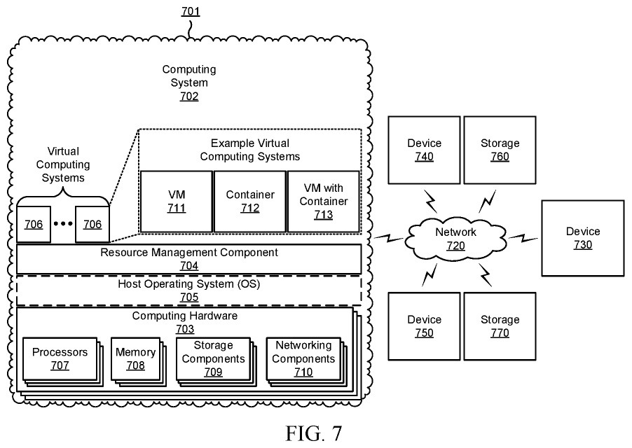

This embodiment discloses a product ordering method. In some embodiments, the method is being implemented by computing system, such as the computing system 702 showing in FIG. 7. As shown in FIG. 1, the method includes the following steps 110 to 130.

Step 110: Determine, by computing system, according to real-time data of secondary products under primary products, merchantable secondary products under the primary products and secondary product types of the merchantable secondary products.

For example, please refer to FIG. 7, in one embodiment, the computing system 702 may be configured to communicate with the storage 760 and 770. In that embodiment, the storage 760 and 770 are both database systems configured to store product information managed by the computing system 702. In that embodiment, the storage 760 may be configured to product information regarding primary products, and the storage 770 may be configured to store product information regarding the secondary products. In implementations, the determination of the merchantable secondary products may involve acquiring product information regarding the primary and secondary products from the storage 760 and 770.

The product ordering method in this embodiment is applicable to ordering of the primary products with which secondary products are associated, and may be widely used in the hotel field, the beauty field, the catering field, and the like. For example, a primary product in the hotel field includes a hotel, and a secondary product associate with the hotel includes a room. A primary product in the beauty field includes a merchant, and a secondary product hung under the merchant includes a beauty item. A primary product in the catering field includes a restaurant, and a secondary product hung under the restaurant includes dishes, and the like. In the embodiment of this disclosure, for example, the ordering method is applied to the hotel field, to describe specific implementations of the ordering method in detail. The primary product is a hotel, and the secondary product is a room hung under the hotel.

In one example, after a target user logs, through a terminal device 730, into a page or an application of an OTA platform provided by computing system 702 and inputs a query condition, the OTA platform first recalls a related hotel (that is, the primary product) according to a query request of the user from the storage 760, and performs preliminary filtering based on existing rough scores. In one example implementation, the OTA platform screens out, according to a preliminary filtering policy, a preset number (for example, 200) of hotels as target hotels to be recommended in a next step, that is, the primary products.

In some embodiments, real-time data of each product under each of the target hotels obtained through the preliminary filtering is obtained by the computing system 702 according to a check-in time and a check-out time input by the target user through the terminal device 730. The real-time data includes but is not limited to: a room status and a price. For example, a room status of each product under each of the target hotels is obtained from room status service. For another example, a price of each product hung under each of the target hotels is obtained from a price service. The room status is used to indicate whether a product is currently bookable, and the price is used to indicate a current price of the product.

Current merchantable secondary products (for example, a bookable room) may be determined by the computing system 720 according to the real-time data of each product under the target hotel, thereby selecting bookable hotels from the target hotels and ordering the bookable hotels. In addition, the merchantable secondary products may be classified by the computing system 720 according to preset secondary product types, to determine secondary product types of the merchantable secondary products. For instance, in this embodiment, the secondary product type may be any of a room type, a bed type, a window type, a meal type, and the like. For example, the secondary product type may be a double room, a twin-bed room, a windowed room, or the like. Each of the merchantable secondary products may belong to a plurality of secondary product types simultaneously. For example, a bookable room may belong to four secondary product types: a business room, a double room, a windowed room, and a room including breakfast.

Step 120: Determine, by the computing system, primary product features of the primary products and user preference features of a target user based on the merchantable secondary products and the secondary product types.

Further, the primary product features of the primary products (that is, the target hotels) and the user preference features of the target user are respectively determined based on the merchantable secondary products and the secondary product types.

During example implementation, the primary product features of the primary products are preset information of the merchantable secondary products determined based on real-time information of the merchantable secondary products of each of the primary products, such as one or more of the following: a real-time price, a stock, a historical sales volume, a historical sales price, and the like. In addition, the primary product features of the primary products are preset information of the merchantable secondary products determined according to all of the secondary product types and based on real-time information of merchantable secondary products corresponding to all of the secondary product types, such as one or more of the following: a price, a stock, a historical sales volume, a historical sales price, and the like. The preset information includes but is not limited to any one or more of the following: a lowest price, an average price, and a median price of the merchantable secondary product, whether a secondary product with a highest sales volume under the primary product is bookable, sales volume ranking of the merchantable secondary product with the highest sales volume in the merchantable secondary products under the primary product in all secondary products under the primary products, a historical total sales volume and an average price corresponding to the merchantable secondary product with the highest sales volume in the merchantable secondary products, a historical total sales volume of each of the merchantable secondary products, a proportion of merchantable secondary products that have historical sales volumes in the merchantable secondary products, and a proportion of the merchantable secondary products of the primary products in all of the secondary products of the primary products.

During one example implementation, the user preference feature is user feature data determined according to data such as a price, a stock, and the like of a secondary product type preferred by the user. In an example, preference scores of the user for different secondary product types, such as different room types, different bed types, different window types, and different meal types are first calculated according to browsing records and purchase records of the target user for rooms (that is, secondary products) under hotels on the OTA platform within a historical period of time, and then the secondary product types preferred by the target user are determined based on the preference scores. Then, stocks and prices of the secondary product types preferred by the target user are determined as the user preference features of the target user according to the stocks and the prices of the merchantable secondary products.

Step 130: Order the primary products according to the primary product features and the user preference features.

During example implementation, the primary product features and the user preference features may be input into a pre-trained ordering model to obtain an ordering score of each of the primary products for the target user, and then the primary products may be ordered according to the ordering scores. In addition, before the ordering scores are determined through the pre-trained ordering model based on the primary product features and the user preference features, the ordering model may be obtained through training. During specific implementation, primary product features and user preference features extracted from primary product sales data and user historical behavior data within a specified period of time are used as training samples, and then the ordering model is obtained through training by using a machine learning method.

During example implementation, the primary products may also be ordered by the computing system by calculating a similarity between the primary product features and a similarity between the user preference features, which is not limited in this disclosure.

According to the product ordering method in various embodiments, the merchantable secondary products under the primary products and the secondary product types of the merchantable secondary products are determined according to the real-time data of the secondary products under the primary products, and then the primary product features of the primary products and the user preference features of the target user are determined based on the merchantable secondary products and the secondary product types, and the primary products are ordered according to the primary product features and the user preference features. Since the products are ordered based on the real-time data of the secondary products hung under the primary products and the primary product features and the user preference features determined based on the secondary products from a perspective of product information and user preferences, users can quickly find appropriate secondary products hung under the primary products, effectively improving accuracy of product ordering.

### Embodiment 2

This embodiment provide a product ordering method. As shown in FIG. 2, the method includes the following steps 210 to 240.

Step 210: Train, by a computing system, an ordering model.

As described above, ordering of primary products may be implemented by for example the computing system 702 shown in FIG. 7 by inputting primary product features and user preference features into a pre-trained ordering model. In this embodiment, in order to facilitate understanding for readers, still for example, the primary product is a hotel and the secondary product is a room hung under the hotel, to illustrate the technical solution of “ordering the primary products according to the primary product features and the user preference features by using the pre-trained ordering model”.

First, a training sample is constructed by the computing system 702 by recording a primary product feature and a user preference feature of a target user displayed each time. An ordering feature obtained by combining the primary product feature and the user preference feature of the target user displayed each time is used as a sample. An ordering feature corresponding to a primary product with a consumption behavior is used as a positive sample, and an ordering feature corresponding to a primary product without consumption behavior is used as a negative sample. During specific implementation, for a method for obtaining the displayed primary product feature and the displayed user preference feature of the target user, reference is made to the following descriptions, and details are not described herein again.

During example implementation, the ordering model may also be trained by the computing system 702 in combination with other features. For example, the ordering model is trained by computing system 702 based on any one or more of the following features: a primary product feature, a user preference feature, a user basic feature, a primary product basic feature, a user-primary product intersection feature, and a contextual feature. The user basic feature may include a registration time, an age, an average price consumed on the platform, a quantity of historical orders, and the like of the user. The primary product basic feature may include a historical sales volume, score, a click rate, and the like of the primary product. The user-primary product intersection feature may include whether the user clicks or purchases the primary product in history. The contextual feature may include a request time, and the like.

The model is then obtained based on the above training sample through learning by training a machine. For example, the ordering model is obtained based on an XGBoost training model.

Finally, the ordering model is applied by the computing system 702 to online ordering.

During example implementation, the training of the ordering model may be an iterative update process. In other words, during the product ordering, ordering features are continuously collected as training samples, and the ordering model is regularly updated and trained.

Step 220: Determine, by the computing system, according to real-time data of secondary products hung under primary products, merchantable secondary products hung under the primary products and secondary product types of the merchantable secondary products.

During example implementation, the determining, by the computing system, according to real-time data of secondary products hung under primary products, merchantable secondary products hung under the primary products and secondary product types of the merchantable secondary products includes: determining, according to the real-time data of the secondary products hung under the primary products, the merchantable secondary products hung under the primary products; and determining the secondary product types of the merchantable secondary products by integrating the merchantable secondary products. In an example, the secondary product type includes: at least one of a room type, a bed type, a window type, and a meal type.

The above real-time data is used to indicate whether the product is currently bookable. During specific implementation, all of the merchantable secondary products hung under the primary products may be determined according to real-time data of all of the products hung under each of the primary products. For example, it may be learned that a secondary product A hung under a hotel 1 is bookable, a secondary product B hung under the hotel 1 is bookable, a secondary product C under a hotel 2 is bookable, and the like.

For different primary products, different product attributes such as different names and different secondary product types are set for respective products hung under the different primary products. Therefore, in order to further improve the accuracy of ordering, the merchantable secondary products hung under the primary products are integrated to determine secondary product types of the merchantable secondary products hung under all of the primary products and further determine a secondary product type of each of the merchantable secondary products.

Secondary product types in different application fields are determined by computing system 702 according to actual application scenarios. For example, in this embodiment, the secondary product types include but are not limited to: any one or more of a room type, a bed type, a window type, and a meal type. In the embodiment of this disclosure, for example, the secondary product types include the room type, the bed type, the window type, and the meal type, to describe the specific technical solution for determining the secondary product types. During specific implementation, each of the secondary product types further includes at least one basic type. For example, the room type is further divided into basic types such as a double room, a single room, a twin-bed room, a triple room, a suite, a single house, a dorm room, and the like. The bed type is further divided into basic types such as one big bed, two big beds, one big bed+one small bed, two small beds, and the like. The window type is further divided into three basic types of windowed, no window, and partially windowed. The meal type is further divided into basic types such as breakfast included, breakfast excluded, and the like.

During specific implementation, a room type of each of the merchantable secondary products is determined according to keywords included in a product name and a preset rule. For example, if the product name includes “bed”, it is determined that the product type of the secondary product is a “dorm room”. If the product name includes “villa” or “single house”, it is determined that the secondary product type of the secondary product is a “single house”. If the product name includes “suite”, it is determined that the secondary product type of the secondary product is a “suite”. If the product name includes “triple room”, “three-bedroom suite”, “three-room suite”, “3-room suite”, and “3-bedroom suite”, it is determined that the secondary product type of the secondary product is a “triple room”. If the product name includes “twin bed room”, “double room, “twin room”, “two-bedroom suite”, “two-room suite”, “2-room suite”, “2-bedroom suite”, “standard room”, “standard double room”, “standard room”, it is determined that the secondary product type of the secondary product is “twin bed room”. If the product name includes “single room”, “single-bedroom suite”, “single-room suite”, “single bed room”, it is determined that the secondary product type of the secondary product is a “single room”. If the product name includes “double room”, “big bed room” “round bed room”, and “superior double room”, it is determined that the secondary product type of the secondary product is a “double room”. In addition, the secondary product type of the product may further be determined by combining product room type information and product name information that are set, so that inconsistency of a room type and a product name uploaded by a merchant can be avoided, thereby improving the accuracy of product ordering.

During example implementation, the secondary product type may be encoded to construct a primary product feature of the merchantable secondary product. For example, codes of the basic types under the room type are respectively: 0=double room, 1=single room, 2=twin-bed room, 3=triple room, 4=suite, 5=single house, and 6=dorm room. Codes of the basic types under the bed type are respectively: 0=one big bed, 1=two big beds, and 2=two small beds. Codes of the basic types under the window type are respectively expressed as: 0=windowed, 1=windowless, and 2=partially windowed. Codes of the basic types under the meal type are respectively expressed as: 0=breakfast included, 1=breakfast excluded. During specific implementation, different secondary product types may be encoded according to a degree of convenience, or may be sequentially encoded by using numbers in ascending order according to descending order of proportions based on proportions of secondary products of all of the secondary product types in all secondary products of the primary product (for example, a hotel).

By classifying the merchantable secondary products based on the secondary product types, a quantity of merchantable secondary products of each of the secondary product types may be determined, or a secondary product type of a current merchantable secondary product may be determined. A value range of the secondary product type is one of corresponding basic types.

Step 230: Determine by the computing system primary product features of the primary products and user preference features of a target user based on the merchantable secondary products and the secondary product types.

Based on the merchantable secondary products and the secondary product types, product-based primary product features of each of the primary products and product-based user preference features of the target user may be further determined.

During example implementation, determining the primary product features of the primary products based on the merchantable secondary products and the secondary product types includes: determining preset information of the merchantable secondary products as the primary product features of the primary products; and determining preset information of the merchantable secondary products of all of the secondary product types as the primary product features of the primary products. The preset information includes but is not limited to any one or more of the following: a lowest price, an average price, and a median price of the merchantable secondary product, whether a secondary product with a highest sales volume under the primary product is bookable, sales volume ranking of the merchantable secondary product with the highest sales volume in the merchantable secondary products in all of the secondary products under the primary products, a historical total sales volume and an average price corresponding to the merchantable secondary product with the highest sales volume in the merchantable secondary products, a historical total sales volume of each of the merchantable secondary products, a proportion of merchantable secondary products that have historical sales volumes in the merchantable secondary products, and a proportion of the merchantable secondary products of the primary product in all of the secondary products.

During example implementation, determining by the information collection component 702 preset information of the merchantable secondary product includes but is not limited to any one or more of the following: determining, according to a real-time price of the merchantable secondary product, the lowest price, the average price, and the median price of the merchantable secondary product hung under the primary products; determining, according to historical data of the secondary products hung under the primary products, whether the product with the highest sales volume under the primary product is bookable; determining, according to the historical data of the secondary products under the primary products, sales volume ranking of the merchantable secondary product with the highest sales volume in the merchantable secondary products under the primary product in all of the secondary products under the primary products; determining, according to the historical data of the secondary products hung under the primary products, the historical total sales volume and the average price corresponding to the merchantable secondary product with the highest sales volume in the merchantable secondary products; determining the historical total sales volume of each of the merchantable secondary products according to the historical data of the secondary products hung under the primary products; determining, according to the historical data of the secondary products hung under the primary products, the proportion of products that have historical sales volumes in the merchantable secondary products hung under the primary products; and determining the proportion of the merchantable secondary products of the primary product in all of the secondary products of the primary products. Then, the above information is used as a part of the primary product features of the primary products.

During specific implementation, the determining preset information of the merchantable secondary products of all of the secondary product types includes: respectively determining merchantable secondary products corresponding to each of the secondary product types for each of the primary products; performing any one or more of the following operations for the merchantable secondary products under each of the secondary product types to determine a primary product feature that is based on the secondary product type: determining, according to the real-time price of the merchantable secondary product, the lowest price, the average price, and the median price of the merchantable secondary products hung under the primary products; determining, according to historical data of the secondary products hung under the primary products, whether the product with the highest sales volume under the primary product is bookable; determining, according to the historical data of the secondary products hung under the primary products, the sales volume ranking of the merchantable secondary product with the highest sales volume in the merchantable secondary products under the primary product in all of the products under the primary products; determining, according to the historical data of the secondary products hung under the primary products, the historical total sales volume and the average price corresponding to the merchantable secondary product with the highest sales volume in the merchantable secondary products; determining the historical total sales volume of each of the merchantable secondary products according to the historical data of the secondary products hung under the primary products; determining, according to the historical data of the secondary products hung under the primary products, the proportion of products that have historical sales volumes in the merchantable secondary products hung under the primary products; and determining the proportion of the merchantable secondary products of the primary product in all of the secondary products of the primary products. Then, the above information is used as a part of the primary product features of the primary products.

During example implementation, the determining user preference features of a target user based on the merchantable secondary products and the secondary product types includes: using, as the user preference features of the target user, stocks and prices of merchantable secondary products of secondary product types preferred by the target user. During specific implementation, for a specific secondary product type preferred by the target user (if there is a windowed room), merchantable secondary products (that is, bookable windowed rooms) corresponding to the secondary product type are searched from the primary products, and a quantity of the merchantable secondary products is collected, to obtain stock information of the merchantable secondary products corresponding to the secondary product type. Further, based on a real-time price of the merchantable secondary product (that is, the bookable windowed room) corresponding to the secondary product type, information such as an average price, a lowest price, and a median price of the merchantable secondary product corresponding to the secondary product type is determined. According to the method, stock information and price information of the merchantable secondary products of each of the secondary product types (such as a windowed room, a double room, and a room including breakfast) are respectively determined. Finally, the stock information and the price information of all of the merchantable secondary products corresponding to all of the secondary product types preferred by the target user are used as the user preference features of the target user.

During example implementation, before the using, as the user preference features of the target user, stocks and prices of merchantable secondary products of secondary product types preferred by the target user, the method further includes: determining preference scores of the target user for all of the secondary product types according to historical behavior data of the target user for products of the secondary product types; and determining, according to the preference scores, the secondary product types preferred by the target user. In an example, the secondary product types preferred by each user may be determined according to browsing data and purchase data of the user for products of each of the secondary product types. For example, a preference score of the user for each room type is first determined according to browsing data and purchase data of the user for a room of the room type, and then a room type with a highest preference score is used as a room type preferred by the user. According to the method, a bed type, a window type, and a meal type preferred by the user may be obtained.

Further, the step of determining preference scores of the target user by the computing system 702 for all of the secondary product types according to historical behavior data of the target user for products of the secondary product types includes: determining the preference scores of the target user for the secondary product types according to the following formula.

$$Score ( user , x ) = {\sum }_{t} {λ}^{t} ( {ω}_{1} \times ClickCount ( user , x , t ) + {ω}_{2} \times PurchaseCount ( user , x , t ) )$$

Score(user,x) represents the preference score of the target user user for the secondary product types x, ClickCount(user,x,t) represents a quantity of times the target user user clicks the products of the secondary product types x within a time t, PurchaseCount(user,x,t) represents a quantity of times the target user user purchases the products of the secondary product types x within the time t, ω₁ is a weight of the click behavior, ω₂ is a weight of the purchase behavior, and λ is a time attenuation factor. During specific implementation, ω₁ is less than ω₂, a value of λ may be 0.999, and a longer time indicates a larger t and a smaller λ^{t}.

For example, the preference score of the target user for a room type (such as a double room) is determined to describe, in detail, a technical solution for determining a preference score of the user for a specific secondary product type below.

First, a browsing record and a purchase record of the user for the double room within a past period of time (for example, three months) are obtained. Then, a quantity of times the user brows the double room within each month in the above browsing record of the three months is determined, and a quantity of times the user purchases the double room within each month in the above purchase record of the three months is determined. It is assumed that browsing records of a first month to a third month are respectively m₁, m₂, and m₃, and purchase records from the first month to the third month are respectively n₁, n₂, and n₃. Assuming that the time t represents a quantity of months from a current time, the preference score of the user for the double room is:

Score(user,double room)=λ³×(ω₁×m₁+ω₂×n₁)+λ²×(ω₁×m₂+ω₂×n₂)+λ¹×(ω₁×m₃+ω₂×n₃).

According to the above method, a preference score of the user for each of the secondary product types may be determined.

Further, for secondary product types of a same category, a secondary product type with a highest preference score is selected as a secondary product type preferred by the user. For example, a preference score of the target user for the double room is 0.9, a preference score for the single room is 0.8, a preference score for the double room is 0.7, a preference score for the triple room is 0.2, a preference score for the suite is 0.5, a preference score for the single house is 0, and a preference score for the dorm room is 0. It is determined, through comparison of the above preference scores, that the preferred room type is the double room.

For the OTA platform, browsing data and purchase data can best reflect user preferences. Therefore, in this disclosure, user preferences are determined based on historical behavior data of browsing and purchasing secondary products of a user.

During specific implementation, the OTA platform may also regularly determines a preference score of a user for each of the secondary product types on the platform based on historical behavior data of the user. Then, when primary products need to be ordered, a secondary product type preferred by a current user may be further determined according to secondary product types of currently merchantable secondary products.

Step 240: Order by the computing system the primary products according to the primary product features and the user preference features.

During example implementation, the primary product feature of each of the primary products and the user preference features of the target user are combined into a set of input feature data to be input into a pre-trained ordering model to obtain ordering scores of all of the primary products for the target user. Then, the primary products are ordered according to the ordering scores. Because the positive sample used during model training is primary product features of primary products purchased or browsed by the user, an ordering score of each piece of feature data reflects a degree of interest of the target user for a primary product corresponding to the feature data. Finally, all of the primary products are ordered according to the ordering scores, and an ordering result matches the degree of interest of the target user for the primary products.

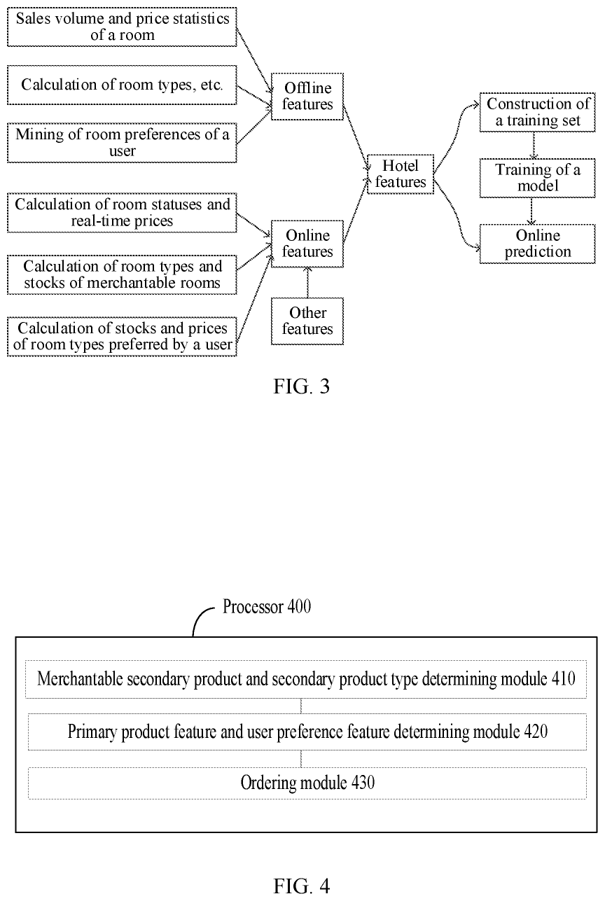

For example, the ordering method in one embodiment is used in the hotel field to order the primary products. A design idea of this disclosure is shown in FIG. 3. Primary product (that is, a hotel) features are constructed through online and offline features of secondary products (that is, rooms), and the primary product features are used for training models and for online prediction. During specific implementation, a training set is first constructed based on hotel features to train an ordering model, and then the trained model is used online, to order target hotels based on hotel features (that is, online features and offline features) of the same category during training of the ordering model. The offline features are calculated based on sales volume statistics information, price statistics information, room type information, and the like of rooms hung under the hotel, and further include features mined from preferences of the user for secondary products. The online features are product features and other features determined based on real-time data of rooms hung under the hotel and real-time information of merchantable rooms hung under the hotel. The features include, for example, features obtained through calculation based on a room status and a real-time price, features obtained through calculation based on room types, stocks, and the like of merchantable rooms, features obtained through calculation based on stocks and prices of room types preferred by the user, and the like.

According to the product ordering method in this embodiment, the merchantable secondary products hung under the primary products and the secondary product types of the merchantable secondary products are determined according to the real-time data of the secondary products hung under the primary products, and then the primary product features of the primary products and the user preference features of the target user are determined based on the merchantable secondary products and the secondary product types, and the primary products are ordered according to the primary product features and the user preference features. Since the products are ordered based on the real-time data of the secondary products hung under the primary products and the primary product features and the user preference features determined based on the secondary products from a perspective of product information and user preferences, users can quickly find appropriate secondary products hung under the primary products, effectively improving accuracy of product ordering.

### Embodiment 3

This embodiment provide a product ordering apparatus. As shown in FIG. 4, the apparatus includes: a processor 400 configured to execute program components including a merchantable secondary product and secondary product type determining module 410, a primary product feature and user preference feature determining module 420, an ordering module 430, and/or any other program components.

The merchantable secondary product and secondary product type determining module 410 is configured to determine, according to real-time data of secondary products hung under primary products, merchantable secondary products hung under the primary products and secondary product types of the merchantable secondary products.

The primary product feature and user preference feature determining module 420 is configured to determine primary product features of the primary products and user preference features of a target user based on the merchantable secondary products and the secondary product types determined by the merchantable secondary product and secondary product type determining module 410.

The ordering module 430 is configured to order the primary products according to the primary product features and the user preference features determined by the primary product feature and user preference feature determining module 420.

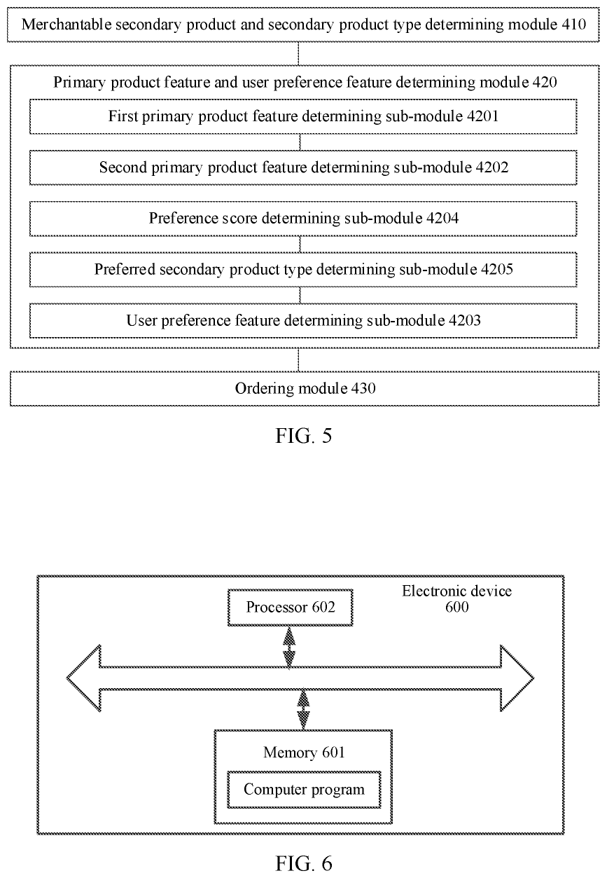

In some embodiments, as shown in FIG. 5, the primary product feature and user preference feature determining module 420 includes: a first primary product feature determining sub-module 4201 and a second primary product feature determining sub-module 4202.

The first primary product feature determining sub-module 4201 is configured to determine preset information of the merchantable secondary products as the primary product features of the primary products.

The second primary product feature determining sub-module 4202 is configured to determine preset information of the merchantable secondary products of all of the secondary product types as the primary product features of the primary products.

In some embodiments, as shown in FIG. 5, the primary product feature and user preference feature determining module 420 further includes: a user preference feature determining sub-module 4203 configured to use, as the user preference features of the target user, stocks and prices of merchantable secondary products of secondary product types preferred by the target user.

In some embodiments, as shown in FIG. 5, the primary product feature and user preference feature determining module 420 further includes: a preference score determining sub-module 4204 and a preferred secondary product type determining sub-module 4205.

The preference score determining sub-module 4204 is configured to determine preference scores of the target user for all of the secondary product types according to historical behavior data of the target user for products of the secondary product types.

The preferred secondary product type determining sub-module 4205 is configured to determine, according to the preference scores determined by the preference score determining sub-module, the secondary product types preferred by the target user.

In some embodiments, the preference score determining sub-module 4204 is further configured to: determine the preference scores of the target user for the secondary product types according to the following formula:

$$Score ( user , x ) = {\sum }_{t} {λ}^{t} ( {ω}_{1} \times ClickCount ( user , x , t ) + {ω}_{2} \times PurchaseCount ( user , x , t ) )$$

Score(user,x) represents the preference scores of the target user user for the specified secondary product types x, ClickCount(user,x,t) represents a quantity of times the target user user clicks the products of the secondary product types x within a time t, PurchaseCount(user,x,t) represents a quantity of times the target user user purchases the products of the secondary product types x within the time t, ω₁ is a weight of the click behavior, ω₂ is a weight of the purchase behavior; and λ is a time attenuation factor. During specific implementation, ω₁ is less than ω₂, a value of λ may be 0.999, and a longer time indicates a larger t and a smaller λ^{t}.

For example, in an application scenario such as a hotel, for the OTA platform, browsing data and purchase data can best reflect user preferences. Therefore, in this disclosure, user preferences are determined based on historical behavior data of browsing and purchasing hotel products of a user.

In some embodiments, the merchantable secondary product and secondary product type determining module 410 is further configured to: determine, according to the real-time data of the secondary products hung under the primary products, the merchantable secondary products hung under the primary products; and determine the secondary product types of the merchantable secondary products by integrating the merchantable secondary products.

This embodiment is an apparatus embodiment corresponding to Embodiment 1 and Embodiment 2. For specific implementations of modules and sub-modules in the apparatus, reference is made to the corresponding parts in Embodiment 1 and Embodiment 2, and details are not described again in this embodiment.

According to the product ordering apparatus disclosed in the embodiment of this disclosure, the merchantable secondary products hung under the primary products and the secondary product types of the merchantable secondary products are determined according to the real-time data of the secondary products hung under the primary products, then the primary product features of the primary products and the user preference features of the target user are determined based on the merchantable secondary products and the secondary product types, and the primary products are ordered according to the primary product features and the user preference features. Since the products are ordered based on the real-time data of the secondary products hung under the primary products and the primary product features and the user preference features determined based on the secondary products from a perspective of product information and user preferences, users can quickly find appropriate secondary products hung under the primary products, effectively improving accuracy of product ordering.

FIG. 6 shows an electronic device 600 that may implement various embodiments in accordance with the present disclosure. As shown, the electronic device includes a memory and a processor. The memory stores a computer program executable on the processor. When the processor executes the computer program, the product ordering method according to Embodiment 1 and Embodiment 2 of this disclosure is implemented. The electronic device may be a PC, a mobile terminal, a personal digital assistant, a tablet computer, or the like.

FIG. 7 is a diagram of an example environment 700 in which systems and/or methods described herein may be implemented. As shown in FIG. 7, environment 700 may include a system 701, which may include one or more elements of and/or may execute within a cloud computing system 702. The computing system 702 may include one or more elements 703-13, as described in more detail below. As further shown in FIG. 7, environment 700 may include a network 20, a first terminal device 730, a terminal device 740, a terminal device 750, a storage device 760, and/or a storage device 770. Devices and/or elements of environment 700 may interconnect via wired connections and/or wireless connections.

The computing system 702 includes computing hardware 703, a resource management component 704, a host operating system (OS) 705, and/or one or more virtual computing systems 706. The resource management component 704 may perform virtualization (e.g., abstraction) of computing hardware 703 to create the one or more virtual computing systems 706. Using virtualization, the resource management component 704 enables a single computing device (e.g., a computer, a server, and/or the like) to operate like multiple computing devices, such as by creating multiple isolated virtual computing systems 706 from computing hardware 703 of the single computing device. In this way, computing hardware 703 can operate more efficiently, with lower power consumption, higher reliability, higher availability, higher utilization, greater flexibility, and lower cost than using separate computing devices.

Computing hardware 703 includes hardware and corresponding resources from one or more computing devices. For example, computing hardware 703 may include hardware from a single computing device (e.g., a single server) or from multiple computing devices (e.g., multiple servers), such as multiple computing devices in one or more data centers. As shown, computing hardware 703 may include one or more processors 707, one or more memories 708, one or more storage components 709, and/or one or more networking components 710. Examples of a processor, a memory, a storage component, and a networking component (e.g., a communication component) are described elsewhere herein.

The resource management component 704 includes a virtualization application (e.g., executing on hardware, such as computing hardware 703) capable of virtualizing computing hardware 703 to start, stop, and/or manage one or more virtual computing systems 706. For example, the resource management component 704 may include a hypervisor (e.g., a bare-metal or Type 1 hypervisor, a hosted or Type 2 hypervisor, and/or the like) or a virtual machine monitor, such as when the virtual computing systems 706 are virtual machines 11. Additionally, or alternatively, the resource management component 704 may include a container manager, such as when the virtual computing systems 706 are containers 12. In some implementations, the resource management component 704 executes within and/or in coordination with a host operating system 705.

A virtual computing system 706 includes a virtual environment that enables cloud-based execution of operations and/or processes described herein using computing hardware 703. As shown, a virtual computing system 706 may include a virtual machine 711, a container 712, a hybrid environment 713 that includes a virtual machine and a container, and/or the like. A virtual computing system 706 may execute one or more applications using a file system that includes binary files, software libraries, and/or other resources required to execute applications on a guest operating system (e.g., within the virtual computing system 706) or the host operating system 705. Although the system 701 may include one or more elements 703-13 of the cloud computing system 702, may execute within the cloud computing system 702, and/or may be hosted within the cloud computing system 702, in some implementations, the system 701 may not be cloud-based (e.g., may be implemented outside of a cloud computing system) or may be partially cloud-based. The system 701 may perform one or more operations and/or processes described in more detail elsewhere herein. Network 20 includes one or more wired and/or wireless networks. For example, network 20 may include a cellular network, a public land mobile network (PLMN), a local area network (LAN), a wide area network (WAN), a private network, the Internet, and/or the like, and/or a combination of these or other types of networks. The network 720 enables communication among the devices of environment 700.

The embodiments in this specification are all described in a progressive manner, each embodiment focuses on a difference from other embodiments, and for same or similar parts in the embodiments, and reference may be made to these embodiments. An apparatus embodiment is basically similar to a method embodiment, and therefore is described briefly; for related parts, reference may be made to the corresponding descriptions in the method embodiment.

The product ordering method and apparatus provided in this disclosure are described in detail above. The principles and implementations of this disclosure are described through specific examples in this specification, and the descriptions of the embodiments are only intended to help understand the methods and core ideas of this disclosure. Meanwhile, a person of ordinary skill in the art may make modifications to the specific implementations and scopes according to the ideas of this disclosure. In conclusion, the content of the specification should not be construed as a limitation to this disclosure.

Through the description of the foregoing implementations, a person skilled in the art may clearly understand that the implementations may be implemented by software in addition to a necessary universal hardware platform, or by hardware, or by hardware. Based on such an understanding, the foregoing technical solutions essentially or the part contributing to the related technology may be implemented in a form of a software product. The computer software product may be stored in a computer-readable storage medium, such as a read-only medium (ROM)/a random access memory (RAM), a magnetic disk, or an optical disc, and includes several instructions for instructing a computer device (which may be a personal computer, a server, a network device, or the like) to perform the methods described in the embodiments or some parts of the embodiments.

1. A method being implemented by a computing system for providing a recommendation to a terminal device associated with a user, the comprising:
obtaining information from a storage device real-time data of secondary products under primary products;
determining, according to real-time data of secondary products under primary products, merchantable secondary products under the primary products and secondary product types of the merchantable secondary products;
determining primary product features of the primary products and user preference features of a target user based on the merchantable secondary products and the secondary product types;
ordering the primary products according to the primary product features and the user preference features; and
sending information regarding the ordered the primary products to the terminal device for display to the user.

2. The method according to claim 1, wherein determining the primary product features of the primary products based on the merchantable secondary products and the secondary product types comprises:
determining preset information of the merchantable secondary products as the primary product features of the primary products; and
determining preset information of the merchantable secondary products of all of the secondary product types as the primary product features of the primary products.

3. The method according to claim 1, wherein determining the user preference features of the target user based on the merchantable secondary products and the secondary product types comprises:
using, as the user preference features of the target user, stocks and prices of merchantable secondary products of secondary product types preferred by the target user.

4. The method according to claim 3, wherein before using, as the user preference features of the target user, the stocks and prices of merchantable secondary products of secondary product types preferred by the target user, the method further comprises:
determining preference scores of the target user for all of the secondary product types according to historical behavior data of the target user for products of the secondary product types; and
determining, according to the preference scores, the secondary product types preferred by the target user.

5. The method according to claim 4, wherein determining the preference scores of the target user for all of the secondary product types according to historical behavior data of the target user for products of the secondary product types comprises:
determining the preference scores of the target user for the secondary product types according to the following formula:
$$Score ( user , x ) = {\sum }_{t} {λ}^{t} ( {ω}_{1} \times ClickCount ( user , x , t ) + {ω}_{2} \times PurchaseCount ( user , x , t ) ) ,$$
wherein
Score(user,x) represents the preference scores of the target user user for the secondary product types x;
ClickCount(user,x,t) represents a quantity of times the target user user clicks the products of the secondary product types x within a time t;
PurchaseCount(user,x,t) represents a quantity of times the target user user purchases the products of the secondary product types x within the time t;
ω₁ is a weight of the click behavior;
ω₂ is a weight of the purchase behavior; and
λ is a time attenuation factor.

6. The method according to claim 1, wherein determining, according to real-time data of secondary products under primary products, the merchantable secondary products under the primary products and secondary product types of the merchantable secondary products comprises:
determining, according to the real-time data of the secondary products hung under the primary products, the merchantable secondary products hung under the primary products; and
determining the secondary product types of the merchantable secondary products by integrating the merchantable secondary products.

7. An apparatus comprising a processor configured to execute program components to cause the apparatus to perform various operations, wherein program components include:
a merchantable secondary product and secondary product type determining module configured to determine, according to real-time data of secondary products hung under primary products, merchantable secondary products hung under the primary products and secondary product types of the merchantable secondary products;
a primary product feature and user preference feature determining module configured to determine primary product features of the primary products and user preference features of a target user based on the merchantable secondary products and the secondary product types determined by the merchantable secondary product and secondary product type determining module; and
an ordering module configured to order the primary products according to the primary product features and the user preference features determined by the primary product feature and user preference feature determining module; and, wherein
the apparatus is caused by the processor to perform:
sending information regarding the ordered the primary products to the terminal device for display to the user.

8. The apparatus according to claim 7, wherein the primary product feature and user preference feature determining module comprises:
a first primary product feature determining sub-module configured to determine preset information of the merchantable secondary products as the primary product features of the primary products; and
a second primary product feature determining sub-module configured to determine preset information of the merchantable secondary products of all of the secondary product types as the primary product features of the primary products.

9. The apparatus according to claim 7, wherein the primary product feature and user preference feature determining module comprises:
a user preference feature determining sub-module configured to use, as the user preference features of the target user, stocks and prices of merchantable secondary products of secondary product types preferred by the target user.

10. The apparatus according to claim 9, wherein the primary product feature and user preference feature determining module further comprises:
a preference score determining sub-module configured to determine preference scores of the target user for all of the secondary product types according to historical behavior data of the target user for products of the secondary product types; and
a preferred secondary product type determining sub-module configured to determine, according to the preference scores determined by the preference score determining sub-module, the secondary product types preferred by the target user.

11. The apparatus according to claim 10, wherein the preference score determining sub-module is further configured to: determine the preference scores of the target user for the secondary product types according to the following formula:
$$Score ( user , x ) = {\sum }_{t} {λ}^{t} ( {ω}_{1} \times ClickCount ( user , x , t ) + {ω}_{2} \times PurchaseCount ( user , x , t ) ) ,$$
wherein
Score(user,x) represents the preference scores of the target user user for the secondary product types x;
ClickCount(user,x,t) represents a quantity of times the target user user clicks the products of the secondary product types x within a time t;
PurchaseCount(user,x,t) represents a quantity of times the target user user purchases the products of the secondary product types x within the time t;
ω₁ is a weight of the click behavior;
ω₂ is a weight of the purchase behavior; and
λ is a time attenuation factor.

12. The apparatus according to claim 7, wherein the merchantable secondary product and secondary product type determining module is further configured to:
determine, according to the real-time data of the secondary products hung under the primary products, the merchantable secondary products hung under the primary products; and
determine the secondary product types of the merchantable secondary products by integrating the merchantable secondary products.

13. An electronic device, comprising: a memory and a processor, wherein the memory stores a computer program executable on the processor, when the processor executes the computer program, the product ordering method according to claim 1 being implemented.

14. A non-transitory computer-readable storage medium storing a computer program, wherein when the computer program is executed by a processor, the product ordering method according to claim 1 is implemented.
